(19) United States
(12) Patent Application Publication
(10) Pub. No.: US 2017/0113274 A1
(43) Pub. Date: Apr. 27, 2017

(54) METHOD FOR MANUFACTURING A METALLIC COMPONENT WHICH IS POSSIBLE TO PICKLE

(71) Applicant: SANDVIK INTELLECTUAL PROPERTY AB, Sandviken (SE)

(72) Inventors: Tomas BERGLUND, Falun (SE); Jouni WEDENSTRAND, Strangnas (SE)

(21) Appl. No.: 15/128,919

(22) PCT Filed: Mar. 24, 2015
(86) PCT No.: PCT/EP2015/056193

§ 371 Date: Sep. 23, 2016

(30) Foreign Application Priority Data
Mar. 25, 2014 (EP) 14161576.5

(51) Int. Cl. B22F 3/15; B22F 3/12; C22C 19/03; F01D 5/14; C23F 1/28; C23F 15/00; B05B 17/00; F16K 25/04; B22F 3/24; C25D 3/56

(52) U.S. Cl. CPC B22F 3/15; B22F 3/24; B22F 3/1291; B22F 3/1266; C22C 19/03; C25D 3/562; C23F 1/28; C23F 15/00; B05B 17/00; F16K 25/04; F01D 5/147; B22F 2003/241; B22F 2301/35; B22F 2301/15

(57) ABSTRACT

A method for manufacturing a metallic component includes the steps of providing a component preform of a metallic material, which constitutes the metallic component and a shaping means which defines the shape of the metallic component. The component preform is subjected to Hot Isostatic Pressing for a predetermined time at a predetermined temperature and a predetermined pressure. The shaping means is removed by contacting the component preform with a pickling agent. The step of providing the component preform includes providing the component preform with an acid resistant metal layer, wherein the acid resistant metal layer is applied with electroplating and wherein the acid resistant metal layer is arranged such that it protects the metallic material from contact with the pickling agent.

### TECHNICAL FIELD

The present disclosure relates to a method for manufacturing a metallic component according to the preamble of claim 1. The present disclosure further relates to a metallic component comprising a body of densified metallic material according to the preamble of claim 13.

### BACKGROUND ART

Hot Isostatic Pressing (HIP) is a preferred method for manufacturing components of near net shape and in high performance materials. In HIP, a capsule which defines the shape of the component is typically manufactured from steel sheets. The capsule is filled with metal- or composite powder and subjected to high temperature and high isostatic pressure so that the metal powder bond metallurgically to a dense component of forge like strength.

Pickling is the most common method of removing the capsule material from HIP:ed part. The HIP:ed part is thereby submerged in warm sulfuric acid (H₂SO₄) for a sufficient period of time so that all the capsule material is removed. This is suitable for parts with complex shapes which make it very difficult to machine the capsule away. When components with internal cavities are manufactured, a solid core is sometimes used for defining the shape of the cavity. After HIP the core is removed by a combination of machining and pickling.

However, when lower alloyed materials such as carbon steel, tool steel and composite materials are used pickling is not suitable for capsule or core removal as the low alloyed materials cannot withstand the acid. In this case the material of the component may be attacked by the acid when the capsule or the core has been dissolved.

Therefore machining is often used for removal of the capsule material. Although machining is a rather costly and cumbersome method, it may be used on external surfaces of simple geometry. However, components with complex surfaces do not permit full capsule removal by machining and in these cases at least portions of the capsule material must be left on the component. Furthermore, some materials e.g. Metal Matrix Composites (MMC) cannot be machined due to their high hardness and to the very high amount of hard particles in the material. In these cases, the capsule has to be left on the component since contact between the MMC material and the machining tool must be avoided. Cores of complex geometries are even more difficult to remove from the HIP:ed component by machining and this put limits to the designs of components with internal channels.

Further, in the HIP process, it is very important that the welds of capsule are gas-tight and also remain tight during the consolidation process. Any leaks will lead to scrapped parts. It is therefore very important that any coating on the inside of the capsule in regions that come into contact with the capsule weld joint does not affect the weld quality.

It is an aspect of the present disclosure to achieve a method for manufacturing metallic components which remedies and/or overcomes at least one of the problems of the prior art.

In particular, it is an aspect of the present disclosure to achieve a method which allows for pickling of metallic components without adverse effects on the metallic component. A further aspect of the present disclosure is to provide a simple and effective method of manufacturing metallic component.

### DEFINITIONS

By the term “shaping means” is meant items or tools which are used in the inventive method for manufacturing the metallic component but which do not form part of the final component and therefore should be removed when the metallic component is finalized. Examples of such “shaping means” are cores or moulds or capsules or forms.

By the term “metallic materials” is meant materials which are metals or composites of metals and non-metallic phases or particles. Examples, but not limiting, of metals are pure metals or alloys of metals and other elements, such as steel. A non-limiting example of composite materials is Metal Matrix Composites, which comprises hard particles, such as, but not limiting to WC, TiC, TaC, TiN or hard phases in a metal matrix, such as, but not limiting to, Ni, Co, Fe, Cr.

### SUMMARY OF THE DISCLOSURE

According to the present disclosure, at least one of the aforementioned aspects is met by the inventive method for manufacturing a metallic component 90 comprising the steps: providing a component preform 10 comprising metallic material 20 which constitutes the metallic component 90 and shaping means 30, 40 which defines the shape of the metallic component 90; subjecting said component preform 10 to Hot Isostatic Pressing for a predetermined time at a predetermined temperature and a predetermined pressure; removing the shaping means 30, 40 by contacting said metallic preform 10 with a pickling agent 60; characterized in that the step 100 of providing the component preform 10 includes providing the component preform 10 with an acid resistant metal layer 50, wherein the acid resistant metal layer 50 is applied with electroplating and wherein the acid resistant metal layer 50 is arranged such that it protects the metallic material 20 from contact with the pickling agent 60.

The acid resistant metal layer provides a barrier to the pickling agent and protects the metallic component during removal of auxiliary shaping means, such as cores or capsules, used in the HIP-process. The presence of the acid resistant metal layer allows for complete removal of the shaping means without risking that the metallic material of the component is attacked by the pickling agent. This in turn allows for effective manufacturing of HIP:ed components. A further advantage is that the rather cumbersome step of removing cores and capsules by machining may be dispensed. The method further allows for the manufacturing of components with complex geometries which prior not have been possible to machine.

Electroplating, which is used for applying the acid resistant metal layer on the component preform is a simple and effective method for coating complicated geometries with a well-defined thickness, e.g. the whole component preform may be coated. A further advantage is that the coating does not need to be machined after application. Further advantages are that the obtained coating does not contain any phosphorus as the electroless coatings normally do, thus the obtained coating will not affect the weld and the weld will therefore be gas-tight

Metals comprising nickel and/or chromium have very good resistance to pickling agents, e.g. sulfuric acid or hydrochloric acid, and therefore provide an effective barrier towards the pickling agent and effectively protect the metallic component during removal of the auxiliary shaping means

According to one embodiment of the present disclosure as defined hereinabove or hereinafter, the acid resistant metal layer 50 is nickel metal. Apart from its good resistance to certain acids used in pickling, such as sulfuric acid (H₂SO₄) and hydrochloric acid (HCl), nickel also has a high melting point i.e. 1455° C. This makes nickel very suitable as an acid resistant metal layer 50 in metallic components manufactured by the HIP-process as nickel maintains its structural stability and remains intact at the high temperatures and pressures that prevail during the HIP-process. Nickel has furthermore low affinity to carbon. This is an important feature in the HIP process as nickel thereby will limit the possibility of carbon diffusion from the metallic material and the acid resistant metal layer 50. Carbon diffusion should be avoided since it may cause the formation of brittle phases in the HIP:ed component.

The nickel metal may have a nickel content of at least 95 wt %. The remainder is constituted from various naturally occurring impurities such P, S, O, Fe, Cu, C and Si. In particular, it is important that the content of phosphorous is lower than 5 wt % in order to maintain the high melting point of the nickel metal. Hence, the acid resistant metal layer should contain at least 95 wt % nickel metal remainder naturally occurring impurities of which the content of phosphorus is <5 wt %, such as <3 wt %, such as <2 wt %. The resistance to the pickling agent as well as the structural stability at high temperatures of the acid resistant metal layer 50 increases with increasing nickel content, thus, the content of nickel may be at least 97 wt %, such as at least 98 wt %, for example the nickel content is 95-98 wt % or 97-98 wt % with remainder unavoidable impurities.

According to an alternative, the acid resistant metal layer 50 is chromium. Chromium is also a metal which has very good resistance to acids. The high melting point of chromium, i.e. 1857° C. makes it suitable to be used as an acid resistant metal layer 50 in the HIP process since it remains intact during the HIP process.

According to an alternative the acid resistant metal layer 50 comprises 5-20 wt % Ni and 20-40 wt % Cr, remainder Fe. The alloy may also comprise additional elements such as Mn and/or Mo, which elements also contribute to the corrosion resistance, such as nickel based alloys such as Alloy 625, 718 and 825.

The acid resistant metal layer 50 may have a thickness of 50-200 μm, such as 75-175 μm, such as 75-125 μm, such as 100 μm. The acid resistant metal layer should be at least 50 μm thick in order to ensure that the layer is continuous without pores which could form entry points for the pickling agent. The probability of a completely pore free layer increases with increasing layer thickness. The upper limit for the thickness is determined by the limits of the coating process. At high thicknesses, i.e. above 200 μm there may be a tendency for the layer to spall off.

According to the method as defined hereinabove or hereinafter, the acid resistant metal layer 50 may be arranged between the shaping means 30, 40 and the metallic material 20. This ensures that the shaping means, in the case that an externally arranged HIP:capsule is used, may be dissolved from the outside and inwards, or in the case of a core from the inside and outwards, whereby the pickling agent is prevented from contacting the component when the shaping means has been fully dissolved.

The acid resistant metal layer 50 may applied directly onto the surface of the shaping means 30, 40. This is an easy and effective way of applying the acid resistant metal layer in a position where it protects the adjacent metallic material of the component preform.

According to one alternative of the method as defined hereinabove or hereinafter, the shaping means 30, 40 may be a capsule 30 defining at least a portion of the form of the metallic component 90. In this alternative, the acid resistant metal layer 50 may be applied directly onto the inner surface of the capsule, i.e. the side of the capsule which faces the metallic material.

According to one alternative of the method, the metallic component 90 may comprise a cavity 92, whereby the shaping means 30, 40 is a core 40 that defines the shape of the cavity 92. In this alternative, the acid resistant metal layer is applied directly onto the surface of the core.

The capsule and the core may be manufactured from very low alloyed steel, such as iron, which has an iron content of at least 95 wt % with remainder naturally occurring impurities such as Mn, C, Si, Mo and V. Low alloyed steel and iron are very suitable materials for the shaping means since they will be dissolved in sulfuric acid in short time.

According to one embodiment of the method as defined hereinabove or hereinafter, the removal of the core 40 involves forming an opening 45 in the core 40. The opening, which may be a recess, a hole or a through hole, increases the surface area that the pickling agent may attack. When the core is provided with a longitudinal bore or a through hole, the removal rate of the core through pickling is increased since the core dissolves over its entire length from the center and outwards, thereby a very effective method of removing the core is achieved.

The step of removal of the core 40 may involve circulating the pickling agent 60 in or through the opening 45 in the core 40. Circulation of the pickling agent increases the dissolving rate of the core since spent pickling agent is continuously removed from the bore and fresh agent pickling supplied.

The present disclosure also relates to a metallic component 90 comprising a body 95 of HIP:ed metallic material, wherein at least a portion of an external surface 91, 93 of the body 95 comprises an acid resistant metal layer 50. By external surface is meant a surface on the final metallic component which is exposed to the surroundings.

The metallic component 90 may comprise a body 95 having an outer wall 91 and an inner wall 93 and a cavity 92 enclosed by the inner wall 93, whereby the inner wall 93 is coated with an acid resistant metal layer 50.

The acid resistant metal layer (50) of the metallic component has been applied by electroplating.

According to the present disclosure the metallic component 90 as defined hereinabove or hereinafter is an atomizer nozzle for the oil industry, or an impeller or a valve spindle.

### BRIEF DESCRIPTION OF DRAWINGS

FIGS. 1-4: Shows schematically the steps of the inventive method.

FIG. 5: Shows schematically a component manufactured by the inventive method.

FIG. 6: Shows schematically a component preform according to an alternative of the inventive method.

FIG. 7: A flow chart showing the order of the main steps of the inventive method.

### DETAILED DESCRIPTION OF EMBODIMENTS

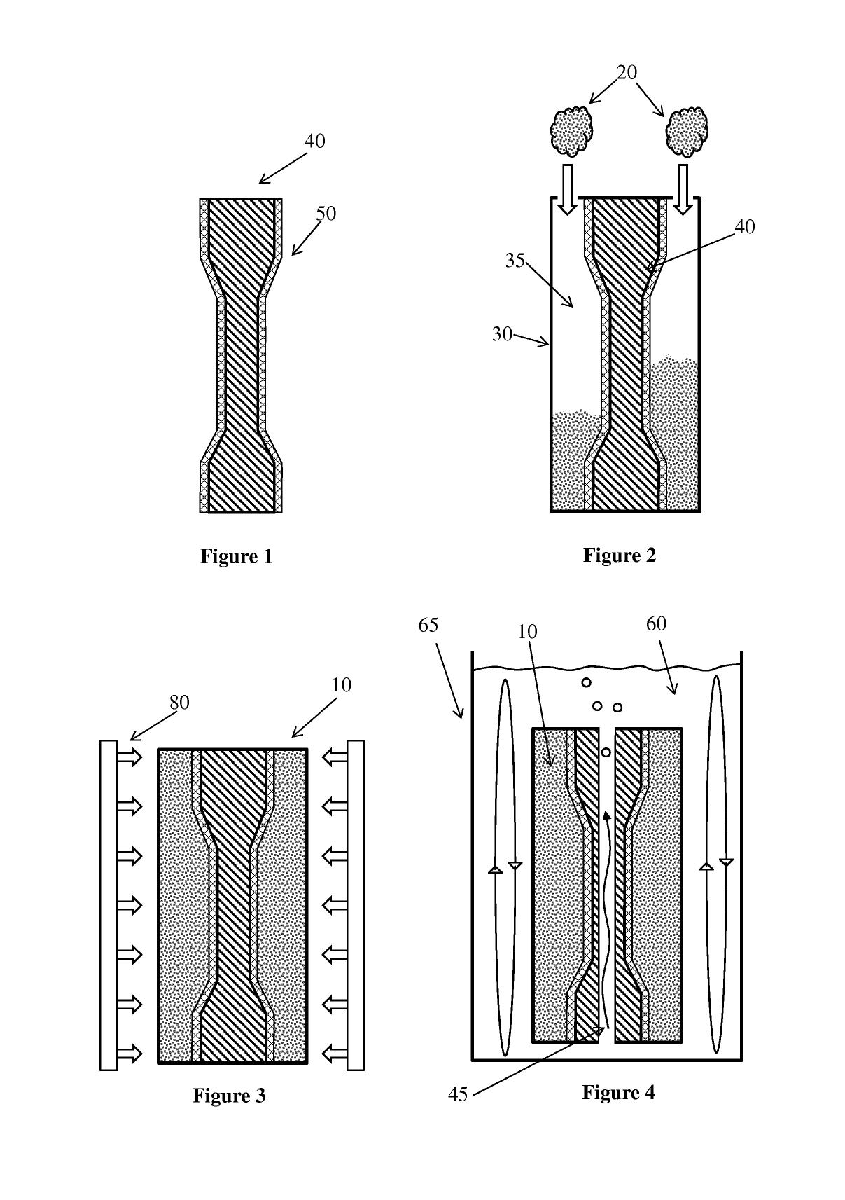

The present disclosure will in the following be described in detail with reference to the manufacturing of a metallic component which comprises an internal cavity. The general order of the main steps of the present disclosure is shown in the flow chart of FIG. 7. The FIGS. 1-6 are schematic, cross-sectional side views.

In the described embodiment, the obtained metallic component is an atomizer nozzle for use in the oil industry. The atomizing nozzle has a through going nozzle bore. However, it should be appreciated that the inventive method as described above and hereinafter, is suitable for the manufacturing of all types of components which requires a pickling step, for example impellers and valve components. Although the described embodiment shows a component with a through going bore, this is not to be understood as limiting for the present disclosure. The inventive method is also very well suitable for the manufacturing of components with solid cross-section, such as bars, blocks and plates or solid cylindrical components such as rolls.

In a first step 100 of the inventive method a component preform is provided. A core 40 is thereby manufactured, FIG. 1 shows a cross-sectional side-view of the core 4. The core 40 will define the form of an internal cavity in the final component, i.e. a nozzle bore in the atomizer nozzle. The core is manufactured from highly pure iron or low alloyed carbon steel, for example commercially available SS2172. Other examples of suitable steels t include S355, S235, SS2142, SS2172, SS1650. These steels, as well as iron, are relatively inexpensive and may be rapidly dissolved by commercially available pickling agents, such as sulfuric acid or hydrochloric acid. The core 40 may be manufactured by conventional methods, such as casting, forging and machining. Obviously, the core may have any form suitable for the component is question.

According to the method as defined hereinabove or hereinafter disclosure, the core 40 is provided with an acid resistant metal layer 50. The acid resistant metal layer 50 has a nickel metal content of more than 95%. The nickel layer is applied by electroplating on the surface of the core. However, the nickel layer may also be applied in the form of a nickel foil. The entire circumferential surface of the core is coated with nickel, i.e. all surfaces of the core which in a subsequent step will be embedded or in contact with the metallic material of the component are coated with nickel. However, depending on the component in question, it is also possible to provide the nickel layer on only selected surfaces of the core. The nickel layer is for example 100 μm thick.

The core 40 is placed in a capsule 30, see FIG. 2, which defines the outer shape of the final component. It is of course also possible to build the capsule 30 around the core, in such case, portions of the capsule could be directly attached to the core, for example the capsule could be attached to the ends of the core. The capsule is typically made from steel sheets having been welded together. The material of the capsule consists of very low alloyed steel or pure iron, i.e. having an iron content of at least 95%. Examples of commercially available steel types are: DC04 or DC05, DC06, S235, S355. The capsule 40 and the core 30 delimit an inner space 35 which defines the form of the final component 90. According to the present method as defined hereinabove or hereinafter, it is also possible to apply the acid resistant metal layer 50 on the inner surface of the capsule, i.e. the side of the capsule facing the inner space 35 (not shown). The acid resistant metal layer 50 will protect the underlying metallic material from coming into contact with the pickling agent when the capsule is removed in the subsequent pickling step.

The inner space 35 is filled with a powder of metallic material 20 which will constitute the body of the final metallic component. The powder of metallic material may be any type of material suitable for the metallic component in question, for example Ni— Co— or Fe alloy powder or high speed steel, such as AISI M3:2. The metallic material 20 may also be a composite powder, i.e. a mixture of metal powder and hard particles such as tungsten carbide or titanium carbide or nitrides such as TiN. It is also possible to use metallic material in the form of solid pieces. During the filling of the powder in the capsule, the capsule is vibrated to compact the powder and thereafter a vacuum is drawn in the capsule and the capsule is sealed by welding any openings shut, i.e. the capsule is air-tight sealed by welding. The arrangement of the core 30, the acid resistant metal layer 50, the capsule 40 and the metallic powder 20 forms a component preform 10.

In a second step 200, the component preform 10 is subjected to Hot Isostatic Pressing for a predetermined time, at a predetermined pressure and at a predetermined temperature so that the component preform is densified. During HIP, the particles of the powder mixture, the capsule, the acid resistant metal layer and the core bond metallurgical to each other whereby a dense, diffusion bonded, coherent HIP:ed component preform is achieved.

The component preform 10 is thereby placed in a HIP-chamber 80, see FIG. 3. The HIP-chamber is pressurized with gas, e.g. argon gas, to an isostatic pressure in excess of 500 bar. Typically the isostatic pressure is from 900-1200 bar. The chamber is heated to a temperature below the melting point of the lowest melting material or phases that may form. The closer to the melting point the temperature is, the higher is the risk for the formation of melted material and unwanted phases. Therefore, the temperature should be as low as possible in the furnace during HIP:ing. However, at low temperatures the diffusion process slows down and the material will contain residual porosity and the metallurgical bond between the particles will become weak. Therefore, the temperature is preferably in range of from 100-300° C. below the melting point of the lowest melting material, for example of from 900-1150° C., or of from 1000-1150° C. The diffusion processes taking place between the materials in the capsule during HIP:ing are time dependent, thus long HIP:ing times are preferred. However, too long times could lead to poor properties of the HIP:ed material due to e.g. grain growth or excessive dissolution of phases. Preferable, the component preform should be HIP:ed for a time period of from 0.5-4 hours, depending on the cross-sectional dimensions of the component in question.

In a third step 300, the HIP:ed component preform is subjected to pickling by contacting the HIP:ed component preform with a pickling agent.

The component preform 10 is thereby placed in a container 65 containing a pickling agent 60, see FIG. 4. The pickling agent is typically a liquid which is capable of dissolving the materials of the core and the capsule. Preferably, the pickling agent is a liquid which comprises sulfuric acid. However, the pickling acid may also be hydrochloric acid. Preferably, the pickling agent is sulfuric acid which is diluted with water, for example 10-15 vol % sulfuric acid and remainder water. The size of the container 65 and the amount of pickling agent 60 are selected such that all parts of the component preform 10 that are to be removed are immersed in pickling agent 60. The component preform is left in the pickling acid for sufficient time to allow complete dissolving of the core and the capsule. The exact pickling time depends on the dimensions of the component and the dimensions of the core and capsule and must be determined in each case.

Instead of submerging the entire component preform in pickling agent, it is also possible to contact only selected portions of the component preform with pickling agent. For example only a portion of the component may be immersed in pickling agent or the pickling agent may be sprayed or poured on the component preform.

To increase the material removal ratio during pickling and thus to decrease the pickling time, various measures may be employed. For example, an opening may be machined in the core. This may, for example, be achieved by drilling a bore 45 through the core 40 so that the pickling acid can enter into the center of the core and remove the core material simultaneous over the entire length of the core. The pickling acid may further be brought to circulate around the capsule of the component preform and also through the hole 45 in the core. Circulation may be realized by pumps. It is also possible to heat the pickling agent to increase the removal rate of material. The pickling agent may thereby be heated to 80-90° C.

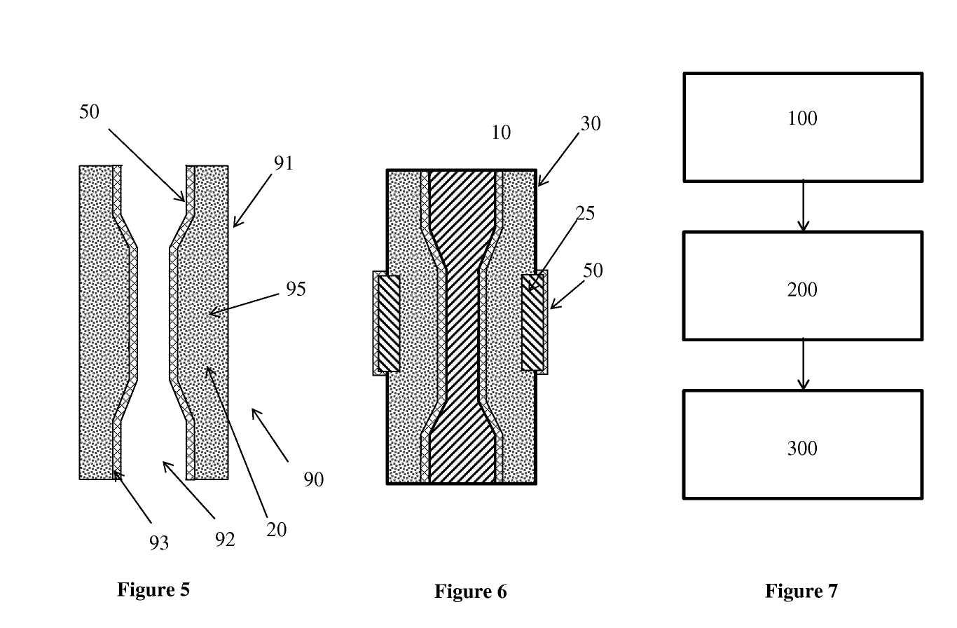

After pickling, the final component is removed from the pickling container 65. FIG. 5 shows schematically the component 90 in its final form. The component consists of a body 95 of densified and diffusion bond metallic material 20. The body 95 has an outer wall 91 and an inner wall 93 and a through hole 92 which has been defined by the core 40 which now is entirely removed. On the surface of the inner wall 93, the acid resistant metal layer 50 remains.

Although particular embodiments have been described in detail, this has been done for illustrative purposes only and is not intended to be limiting. In particular, it is contemplated that various substitutions, alterations and modifications may be made within the scope of the appended claims.

For example, FIG. 6 shows an alternative embodiment the inventive method. In this case the component preform 10 comprises ring shaped solid steel element 25 which forms part of the final component, e.g. as a reinforcement. The capsule 30 is welded to the ring shaped steel element 25 so that the metallic powder 20 partially is enclosed by the capsule 10 and partially enclosed by the ring shaped steel element 25. This arrangement saves capsule material and preparation time when building the component preform. However, in the arrangement shown in FIG. 4, the ring shaped steel element 25 is exposed to the surroundings. According to the present disclosure, the ring shaped element 25 is therefore provided with an acid resistant metal layer 50 in order to protect it from contact with the pickling agent during the pickling step.

1. A method for manufacturing a metallic component comprising the steps of:
providing a component preform of a metallic material which constitutes the metallic component and shaping means which defines the shape of the metallic component;
subjecting the component preform to Hot Isostatic Pressing for a predetermined time at a predetermined temperature and a predetermined pressure;
removing the shaping means by contacting said component preform with a pickling agent, wherein the step of providing the component preform includes providing the component preform with an acid resistant metal layer, wherein the acid resistant metal layer is applied with electroplating and wherein the acid resistant metal layer is arranged such that it protects the metallic material from contact with the pickling agent.

2. The method according to claim 1, wherein the acid resistant metal layer contains nickel metal having a nickel content of at least 95 wt % remainder naturally occurring impurities of which the content of phosphorus is <5 wt %.

3. The method according to claim 1, wherein the acid resistant metal layer is chromium metal.

4. The method according to claim 1, wherein the acid resistant metal layer is a nickel and/or chromium containing alloy.

5. The method according to claim 1, wherein the acid resistant metal layer has a thickness of 50-200 μm.

6. The method according to claim 1, wherein the acid resistant metal layer is arranged between the shaping means and the metallic material.

7. The method according to claim 1, wherein the acid resistant metal layer is applied directly onto the shaping means.

8. The method according to claim 1, wherein the shaping means are made from iron or low alloy carbon steel.

9. The method according to claim 1, wherein the shaping means is a core defining the shape of a cavity in the metallic component.

10. The method according to claim 9, wherein removal of the core involves forming an opening in the core.

11. The method according to claim 10, wherein removal of the core involves the step of circulating pickling agent in the opening in the core.

12. A metallic component comprising a body of HIP:ed metallic material, wherein at least a portion an outer surface of the body includes an acid resistant metal layer.

13. The metallic component according to claim 12, wherein the body includes an outer wall, an inner wall and a cavity enclosed by the inner wall, wherein the inner wall is coated with an acid resistant metal layer.

14. The metallic component according to claim 12, wherein the acid resistant metal layer is applied by electroplating.

15. The metallic component according to claim 12, wherein the metallic component is an atomizer nozzle, an impeller or a valve component.
